(19) United States
(12) Patent Application Publication
(10) Pub. No.: US 2024/0377262 A1
(43) Pub. Date: Nov. 14, 2024

(54) ARITHMETIC APPARATUS AND ELECTRONIC EQUIPMENT

(71) Applicant: CANON KABUSHIKI KAISHA, Tokyo (JP)

(72) Inventors: YOSHIHISA SUZUKI, Tokyo (JP); HIRONORI NAKA, Tokyo (JP)

(21) Appl. No.: 18/652,934

(22) Filed: May 2, 2024

(30) Foreign Application Priority Data
May 11, 2023 (JP) 2023-078701

(51) Int. Cl. G01K 1/02; G06F 1/3206

(52) U.S. Cl. CPC G01K 1/028; G06F 1/3206

(57) ABSTRACT

An arithmetic apparatus that comprises a temperature detection unit and calculates a detection result obtained by the temperature detection unit, the apparatus comprising a first processing unit configured to perform arithmetic processing based on a first voltage, and a second processing unit configured to perform arithmetic processing based on a second voltage, wherein the apparatus includes, as operation modes, a first mode of supplying both the first voltage and the second voltage and a second mode of suppressing supply of the first voltage, and the temperature detection unit outputs a detection result to the first processing unit in the first mode and outputs a detection result to the second processing unit in the second mode.

### BACKGROUND OF THE INVENTION

### Field of the Invention

The present invention mainly relates to an arithmetic apparatus.

### Description of the Related Art

Electronic equipment requiring temperature control or temperature management can be generally provided with a temperature detection device for detecting the temperature of an object (see Japanese Patent Laid-Open No. 2014-2081).

Some pieces of electronic equipment that operate based on a plurality of power systems are required to continue temperature detection even in the power saving mode in which some of the power systems are suppressed. Accordingly, it is generally required to use a technique of properly continuing temperature detection while reducing power consumption in the power saving mode.

### SUMMARY OF THE INVENTION

The present invention provides a technique advantageous in properly continuing temperature detection while reducing power consumption in the power saving mode.

One of the aspects of the present invention provides an arithmetic apparatus that comprises a temperature detection unit and calculates a detection result obtained by the temperature detection unit, the apparatus comprising a first processing unit configured to perform arithmetic processing based on a first voltage, and a second processing unit configured to perform arithmetic processing based on a second voltage, wherein the apparatus includes, as operation modes, a first mode of supplying both the first voltage and the second voltage and a second mode of suppressing supply of the first voltage, and the temperature detection unit outputs a detection result to the first processing unit in the first mode and outputs a detection result to the second processing unit in the second mode.

Further features of the present invention will become apparent from the following description of exemplary embodiments (with reference to the attached drawings).

### BRIEF DESCRIPTION OF THE DRAWINGS

FIG. 1 is a block diagram showing an example of the arrangement of an arithmetic apparatus according to an embodiment;

FIG. 2 is a flowchart showing control contents when the normal mode shifts to the power saving mode;

FIG. 3 is a flowchart for the execution of temperature detection processing in the power saving mode;

FIG. 4 is a flowchart showing control contents when the power saving mode shifts to the normal mode;

FIG. 5 is a flowchart showing control contents when the normal mode shifts to the power saving mode; and

FIG. 6 is a flowchart showing control contents when the power saving mode shifts to the normal mode.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

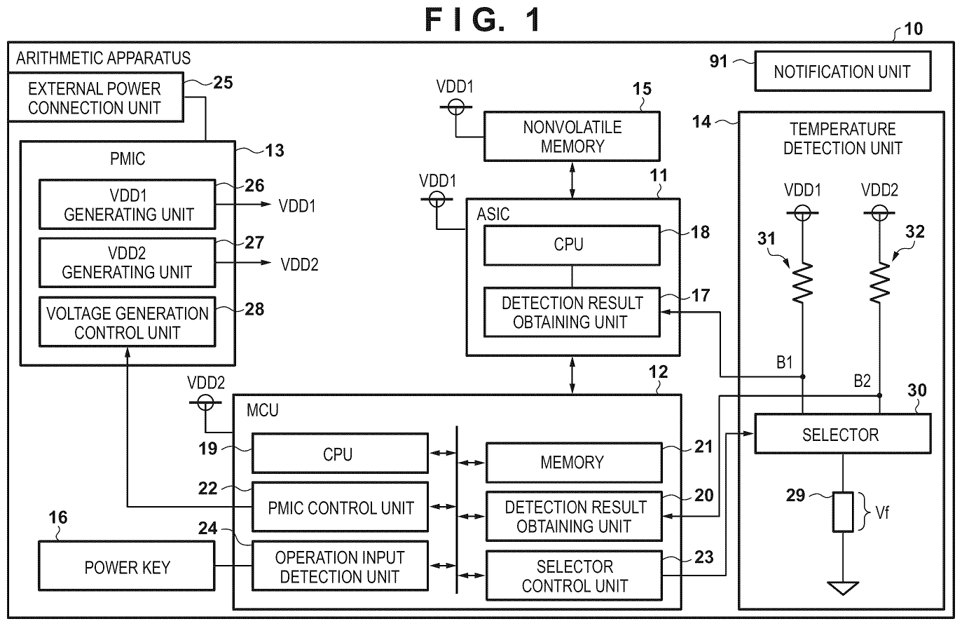

FIG. 1 shows an example of the arrangement of an arithmetic apparatus 10 according to the first embodiment. Although described in detail later, the arithmetic apparatus 10 performs arithmetic processing for a temperature detection result. The arithmetic apparatus 10 can be applied to various types of electronic equipment including a driving device that performs drive control based on the arithmetic result and can be applied to, for example, an inkjet printer that performs image formation by driving a printhead that can discharge ink using heat energy by using an electrothermal conversion element.

The arithmetic apparatus 10 includes a first processing unit 11, a second processing unit 12, a power management integrated circuit (PMIC) 13, a temperature detection unit 14, a nonvolatile memory 15, a power key 16, and an external power connection unit 25. Assume that an application specific integrated circuit (ASIC) is used as the first processing unit 11, which performs predetermined arithmetic processing based on a voltage VDD1. Assume that a micro controller unit (MCU) is used as the processing unit 12, which performs another kind of arithmetic processing based on a voltage VDD2 lower than the voltage VDD1.

The processing unit 11 includes a central processing unit (CPU) 18 and a detection result obtaining unit 17. The processing unit 12 includes a CPU 19, a detection result obtaining unit 20, a memory 21, a PMIC control unit 22, a selector control unit 23, and an operation input detection unit 24. Although described in detail later, the processing units 11 and 12 perform predetermined arithmetic processing by using the CPUs 18 and 19 based on the detection results respectively obtained from the temperature detection unit 14 by the detection result obtaining units 17 and 20.

The processing units 11 and 12 can perform arithmetic processing for driving or controlling a predetermined target. The processing unit 11 is higher in the percentage of analog circuit configuration than the processing unit 12 and can generally consume relatively large power. In the following description, although the processing units 11 and 12 are respectively termed as the ASIC 11 and the MCU 12, the processing units 11 and 12 each may be expressed as a driving unit, a control unit, or the like and may be incidentally discriminated from each other by being attached with “first”, “second”, “main”, “sub”, or the like.

The ASIC 11 and the MCU 12 can mutually communicate by a known scheme such as an inter-integrated circuit (I2C) or serial peripheral interface (SPI).

The arithmetic apparatus 10 includes a normal mode (first mode) and a power saving mode (second mode) as operation modes. In the normal mode, the ASIC 11 operates based on the voltage VDD1, and the MCU 12 operates based on the voltage VDD2. In the power saving mode, the ASIC 11 is set in the sleep state, and the MCU 12 continues operating based on the voltage VDD2.

Note that “voltage” can indicate a potential relative to a ground potential but may be reworded as “power” encompassing “current supply amount” in consideration of the spirit of the operation modes described above.

The PMIC 13 includes a first voltage generating unit (VDD1 generating unit) 26 and a second voltage generating unit (VDD2 generating unit) 27. The voltage generating units 26 and 27 respectively generate the voltage VDD1 and the voltage VDD2 based on an external voltage supplied via the external power connection unit 25. That is, the PMIC 13 generates both the voltages VDD1 and VDD2 in the normal mode and generates the voltage VDD2 but suppresses the generation of the voltage VDD1 in the power saving mode.

In addition, the PMIC 13 further includes a voltage generation control unit 28 for executing power supply or controlling the stoppage of power supply with respect to each of the generated voltages VDD1 and VDD2. In this embodiment, the voltage generation control unit 28 can control each of the voltage generating units 26 and 27 based on the control signal received from the PMIC control unit 22 of the MCU 12.

For the sake of easy understanding, the following description will be made on the assumption that the voltage VDD1 is not generated in the power saving mode. However, the ASIC 11 may partially operate on power lower than that in the normal mode.

The temperature detection unit 14 includes a selector 30, resistive elements 31 and 32, and an electric element 29. Assume that a multiplexer is used as the selector 30 and includes outputs B1 and B2 and an input S in this embodiment. One end and the other end of the resistive element 31 are respectively connected to the voltage VDD1 and the output B1 of the selector 30. One end and the other end of the resistive element 32 are respectively connected to the voltage VDD2 and the output B2 of the selector 30. The resistive elements 31 and 32 can also be expressed as pull-up resistors in this arrangement.

In addition, the electric element 29 may be configured to vary in resistance value with a change in temperature. For example, a resistive element or rectifier element, more specifically, a thermistor can be used as the electric element 29. One end and the other end of the electric element 29 are respectively connected to the input S of the selector 30 and a ground line (grounded). If, for example, the electric element 29 is a rectifier element, the anode and the cathode of the electric element are respectively connected to the input S of the selector 30 and a ground line.

The temperature detection unit 14 is used to detect the temperature of a printhead that discharges ink, the atmospheric temperature inside the arithmetic apparatus 10, the temperature of an ink tank storing ink, and the like.

The selector 30 connects the input S to one of the outputs B1 and B2 based on a control signal from the selector control unit 23. When, for example, the input S is connected to the output B1, the selector 30 outputs a divided voltage value (that is, a voltage Vf generated by the electric element 29) of the voltage VDD1 based on the resistance ratio between the elements 29 and 31 as a temperature detection result to the detection result obtaining unit 17 of the ASIC 11. In addition, when the input S is connected to the output B2, the selector 30 outputs the divided voltage value Vf of the voltage VDD2 based on the resistance ratio between the elements 29 and 32, as a temperature detection result, to the detection result obtaining unit 20 of the MCU 12.

In the ASIC 11, the detection result obtaining unit 17 analog/digital-converts the detection result received from the temperature detection unit 14 in this manner, and the CPU 18 performs signal processing for the detection result obtained in this manner as a digital signal. Likewise, in the MCU 12, the detection result obtaining unit 20 analog/digital-converts the detection result received from the temperature detection unit 14, and the CPU 19 performs signal processing for the detection result obtained in this manner as a digital signal. Such signal processing can be simply expressed as “temperature detection processing” in the following description.

Under the same environment, there can be an error between the divided voltage value Vf input to the detection result obtaining unit 17 of the ASIC 11 and the divided voltage value Vf input to the detection result obtaining unit 20 of the MCU 12. This error is caused by, for example, the difference between the voltages VDD1 and VDD2 generated by the PMIC 13 and the resistance value difference accompanying the manufacture variations of the resistive elements 31 and 32.

The nonvolatile memory 15 can write/read information or data based on the voltage VDD1 in the normal mode, and can also use the nonvolatile memory 15 even after the normal mode is restored from the power saving mode. A known storage device such as a flash memory may be used as the nonvolatile memory 15.

The power key 16 functions as an operation input unit for switching the above operation modes. For example, when the power key 16 is pressed during the normal mode, the operation mode shifts to the power saving mode, whereas when the power key 16 is pressed during the power saving mode, the operation mode shifts to the normal mode. Although described in detail later, the MCU 12 causes the operation input detection unit 24 to detect whether the power key 16 is pressed and performs temperature detection processing in response to the detection result.

Note that an operation input for switching the above operation modes is not limited to the pressing of the power key 16 and may be performed by another mode.

The arithmetic apparatus 10 further includes a notification unit 91 for performing predetermined notification. The notification unit 91 may be a light source, a sound source, or a signal for outputting an image to a display.

In the normal mode, the ASIC 11 generally consumes relatively large power, and the power consumption can further increase with increases in operating frequency, circuit size, and the like. Temperature detection processing is preferably performed by the ASIC 11 operating based on the voltage VDD1 for the purpose of, for example, accurately detecting a temperature. In contrast to this, in the power saving mode, temperature detection processing is performed by the MCU 12 in this embodiment because the voltage VDD1 is not supplied to the ASIC 11 and/or for the purpose of preventing the ASIC 11 from being unnecessarily activated. This makes it possible to continuously execute temperature detection processing even in the power saving mode.

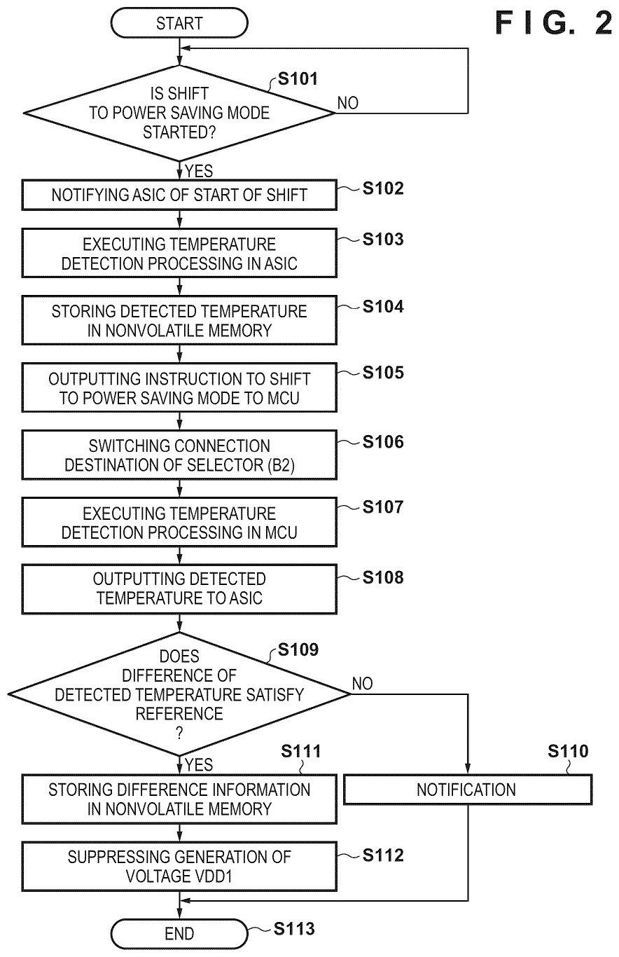

FIG. 2 is a flowchart showing control contents when the normal mode shifts to the power saving mode. Before the shift, in the selector 30, the input S is connected to the output B1 (the output B1 is selected), and the temperature detection result obtained by the temperature detection unit 14 is output to the ASIC 11 (the detection result obtaining unit 17 of the ASIC 11).

In step S101 (to be simply referred to as “S101” hereinafter; the same applies to other steps described below), the shift to the power saving mode is started in response to the detection of the pressing of the power key 16 by the operation input detection unit 24.

In S102, in response to the detection of the pressing of the power key 16, the MCU 12 notifies the ASIC 11 of the start of the shift to the power saving mode.

In S103, in response to the notification, the ASIC 11 causes the detection result obtaining unit 17 to execute temperature detection processing based on the voltage Vf of the output B1 of the selector 30 and stores the result as a detected temperature in the nonvolatile memory 15 in S104.

In S105, the ASIC 11 outputs an instruction to shift to the power saving mode to the MCU 12.

In S106, in response to the instruction to shift, the MCU 12 causes the selector control unit 23 to switch the connection destination of the input S of the selector 30 to the output B2, thereby generating the divided voltage value Vf based on the voltage VDD2 at the output B2.

In S107, in response to the switching of the connection destination of the input S, the MCU 12 causes the detection result obtaining unit 20 to execute temperature detection processing based on the divided voltage value Vf of the output B2 of the selector 30 and outputs the result as a detected temperature to the ASIC 11 in S108.

In S109, the ASIC 11 calculates the difference between the detected temperature obtained in S103 and the detected temperature received from the MCU 12 in S108 and determines whether the difference satisfies a reference (for example, whether the difference falls within an allowable range). If the difference satisfies the reference, the process advances to S111. If the difference is equal to or more than the reference, the process advances to S110.

In S110, it is determined that the difference between the detected temperature obtained by the ASIC 11 and the detected temperature obtained by the MCU 12 is equal to or more than the reference, and the notification unit 91 performs predetermined notification. Although this notification may be performed with respect to the user, the arithmetic apparatus 10 may be shut down or rebooted instead. Thereafter, this flowchart is ended in S113, that is, the shift to the power saving mode is suppressed.

In S111, it is determined that the difference between the detected temperature obtained by the ASIC 11 and the detected temperature obtained by the MCU 12 satisfies the reference, and the ASIC 11 stores information indicating the difference as difference information in the nonvolatile memory 15.

In S112, the MCU 12 causes the PMIC control unit 22 to output a control signal (pause signal) for inactivating the voltage generating unit 26 and causes the voltage generation control unit 28 to suppress the generation of the voltage VDD1. Thereafter, this flowchart is ended in S113, that is, the shift to the power saving mode is completed.

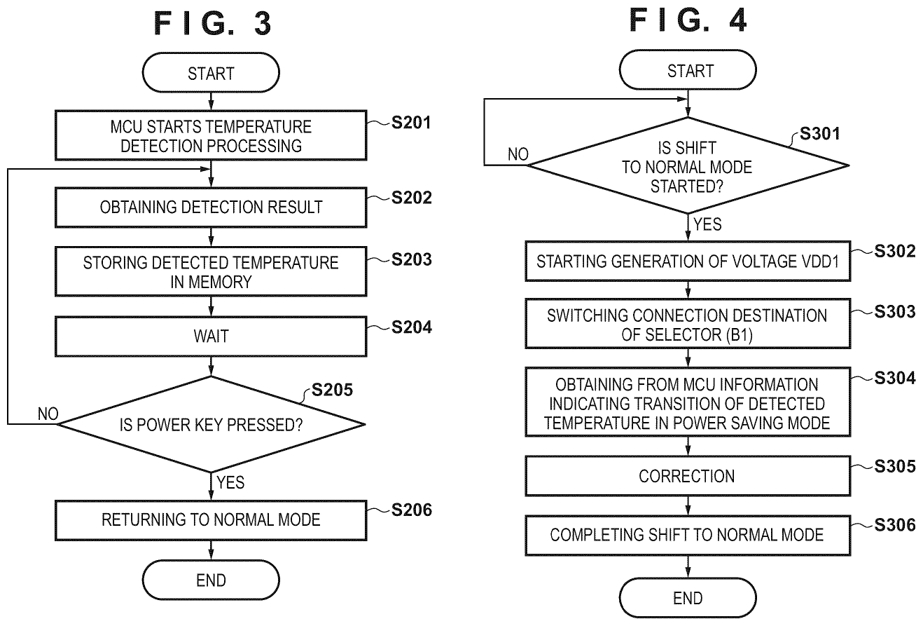

FIG. 3 is a flowchart for the execution of temperature detection processing in the power saving mode. After the shift, the input S is connected to the output B2 (the output B2 is selected) in the selector 30, and the temperature detection result obtained by the temperature detection unit 14 is output to the MCU 12 (the detection result obtaining unit 20 of the MCU 12).

In S201, after the shift to the power saving mode, the MCU 12 starts temperature detection processing.

The detection result obtaining unit 20 obtains a detection result in S202 and stores the obtained detected temperature in the memory 21 in step S203.

In S204, standby is maintained for a predetermined time (for example, 1 min).

In S205, it is determined whether the power key 16 indicating restoration from the power saving mode to the normal mode is pressed. If the power key 16 is pressed, the process advances to S206 to restore the normal mode and end this flowchart. In contrast to this, if the power key 16 is not pressed, the process returns to S202, that is, the MCU 12 executes temperature detection processing in a predetermined cycle.

In this case, the shift from the power saving mode to the normal mode is expressed as restoration in contrast to the shift from the normal mode to the power saving mode, but both the shift and the restoration may be expressed as shifts.

FIG. 4 is a flowchart showing control contents when the power saving mode of the arithmetic apparatus 10 is restored to the normal mode. Before the restoration, the input S is connected to the output B2 (the output B2 is selected) in the selector 30, and the temperature detection result obtained by the temperature detection unit 14 is output to the MCU 12 (the detection result obtaining unit 20 of the MCU 12).

In S301, in response to the detection of the pressing of the power key 16 by the operation input detection unit 24, the shift to the normal mode is started.

In S302, with the shift to the normal mode, the MCU 12 causes the PMIC control unit 22 to control the voltage generating unit 26 to start the generation of the voltage VDD1.

In S303, the MCU 12 causes the selector control unit 23 to switch the connection destination of the input S of the selector 30 to the output B1, thereby generating the divided voltage value Vf based on the voltage VDD1 at the output B1. That is, the ASIC 11 causes the detection result obtaining unit 17 to execute temperature detection processing based on the voltage Vf of the output B1.

In S304, the ASIC 11 obtains information indicating the transition of the detected temperature obtained in S201 in the power saving mode from the MCU 12.

In S305, the detection result obtained by the detection result obtaining unit 20 of the MCU 12 is corrected based on the transition of the detected temperature obtained in S304 in the power saving mode and the difference information stored in the nonvolatile memory 15 in step S111. This makes it possible to eliminate the error that can occur between the detected temperature obtained by the ASIC 11 and the detected temperature obtained by the MCU 12.

In S306, the ASIC 11 resumes temperature detection processing, and this flowchart is ended, that is, the restoration to the normal mode is completed.

According to this embodiment, in the normal mode, the ASIC 11 performs temperature detection processing, and when the normal mode shifts to the power saving mode, the detected temperature error that can occur between the ASIC 11 and the MCU 12 is stored as difference information in the nonvolatile memory 15. In the power saving mode, the MCU 12 performs temperature detection processing and stores the result in the memory 21. When the power saving mode restores to the normal mode, the ASIC 11 receives the detection result stored in the memory 21 from the MCU 12 and performs correction based on the difference information (the above error) stored in the nonvolatile memory 15. This makes it possible to properly implement continuous execution of temperature detection processing regardless of the operation mode.

### Second Embodiment

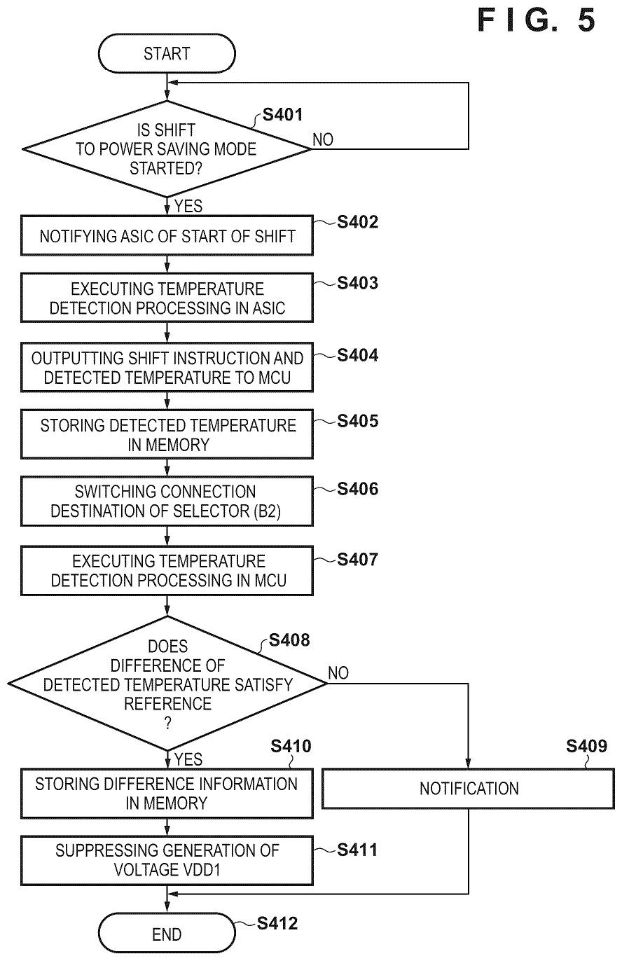

FIG. 5 is a flowchart showing another example of control contents when the normal mode shifts to the power saving mode according to the second embodiment.

S401 to S403 are respectively the same as S101 to S103 (see FIG. 2) in the first embodiment described above.

In S404, an ASIC 11 transmits the temperature detection processing result obtained by a detection result obtaining unit 17 in S403 as a detected temperature to an MCU 12 together with an instruction to shift to the power saving mode. In S405, the MCU 12 stores the transmitted detected temperature to a memory 21.

S406 and S407 are respectively the same as S106 and S107 in the first embodiment described above. S408 and S409 are respectively the same as S109 and S110 in the first embodiment described above.

In S410, the MCU 12 stores the detected temperature difference between the ASIC 11 and the MCU 12 as difference information in the memory 21 (that is, this embodiment differs in storage destination from S111 in which difference information is stored in a nonvolatile memory 15).

S411 and S412 are respectively the same as S112 and S113 in the first embodiment described above.

That is, the second embodiment mainly differs from the first embodiment in that when performing correction for eliminating a detected temperature error that can occur between the ASIC 11 and the MCU 12, the first embodiment and the second embodiment respectively use the nonvolatile memory 15 and the memory 21. A known storage device such as a DRAM may be used as the memory 21. The memory 21 can also function as the work memory of a CPU 19 in the normal mode and the power saving mode.

The second embodiment can obtain the same effect as that of the first embodiment described above by using the memory 21 that is relatively inexpensive without using the nonvolatile memory 15. In addition, it is possible to comprehensively manage information required for the above correction in the memory 21, and hence it is possible to relatively easily implement the same function as that of the first embodiment.

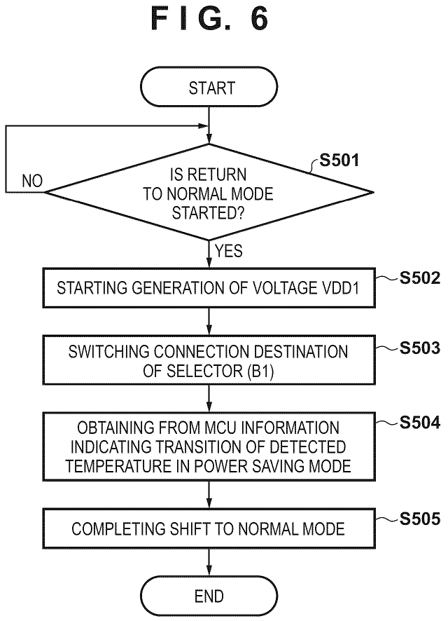

FIG. 6 is a flowchart showing control contents according to this embodiment when the power saving mode of the arithmetic apparatus 10 shifts to the normal mode. S501 to S504 are respectively the same as S301 to S304 (see FIG. 4) in the first embodiment described above. S505 is the same as S306 in the first embodiment described above.

That is, this embodiment can performs the correction in S305 based on only the information stored in the memory 21 but need not refer to the nonvolatile memory 15. This makes it possible to relatively quickly implement the correction for eliminating the detected temperature error that can occur between the ASIC 11 and the MCU 12.

The first and second embodiments are configured to perform the correction for eliminating the detected temperature error that can occur between the ASIC 11 and the MCU 12 when restoring the normal mode from the power saving mode. However, the timing is not limited to this example. For example, this correction may be performed when the normal mode shifts to the power saving mode. This can also eliminate the error that can occur between the operation modes.

### Others

In the embodiments, individual elements are named by expressions based on their main functions. However, the functions described in the embodiments may be sub-functions, and the expressions are not strictly limited. Furthermore, the expressions can be replaced with similar expressions. In the same vein, an expression “unit (portion)” can be replaced with an expression “tool”, “component”, “member”, “structure”, “assembly”, or the like. Alternatively, these may be omitted or added.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-078701, filed May 11, 2023, which is hereby incorporated by reference herein in its entirety.

What is claimed is:

1. An arithmetic apparatus that comprises a temperature detection unit and calculates a detection result obtained by the temperature detection unit, the apparatus comprising:
a first processing unit configured to perform arithmetic processing based on a first voltage; and
a second processing unit configured to perform arithmetic processing based on a second voltage,
wherein the apparatus includes, as operation modes, a first mode of supplying both the first voltage and the second voltage and a second mode of suppressing supply of the first voltage, and
the temperature detection unit outputs a detection result to the first processing unit in the first mode and outputs a detection result to the second processing unit in the second mode.

2. The apparatus according to claim 1, wherein the temperature detection unit includes a selector configured to switch an output destination of a detection result.

3. The apparatus according to claim 1, wherein the second voltage is lower than the first voltage.

4. The apparatus according to claim 1, wherein in the second mode, supply of the first voltage is stopped, and the second voltage is supplied.

5. The apparatus according to claim 2, wherein the first processing unit is higher in percentage of analog circuit configuration than the second processing unit.

6. The apparatus according to claim 2, wherein the first processing unit and the second processing unit are configured to mutually communicate, and
one of the first processing unit and the second processing unit corrects a detection result received from the selector based on a detection result received by the other of the first processing unit and the second processing unit.

7. The apparatus according to claim 2, further comprising an operation input unit configured to receive an operation input for switching the first mode and the second mode,
wherein the first processing unit and the second processing unit are configured to mutually communicate, and
if the operation input unit receives an operation input for a shift from the first mode to the second mode, the selector outputs a detection result to the second processing unit before the shift, and the first processing unit suppresses the shift if an error between a detection result received by the first processing unit from the selector and a detection result received by the second processing unit from the selector is not less than a reference.

8. The apparatus according to claim 7, further comprising a notification unit configured to output a predetermined notification if the error is not less than the reference.

9. The apparatus according to claim 2, wherein the temperature detection unit further includes a first resistive element configured to receive the first voltage, a second resistive element configured to receive the second voltage, and an electric element connected in series with both the first resistive element and the second resistive element.

10. The apparatus according to claim 9, wherein the electric element is a third resistive element.

11. The apparatus according to claim 9, wherein the electric element is a rectifier element.

12. The apparatus according to claim 9, wherein the selector is arranged in an electric path between each of the first resistive element and the second resistive element and the electric element.

13. Electronic equipment comprising:
an arithmetic apparatus defined in claim 1; and
a driving device configured to perform drive control based on a calculation result concerning a detection result obtained by the temperature detection unit.
